(19) United States
(12) Patent Application Publication
(10) Pub. No.: US 2017/0294716 A1
(43) Pub. Date: Oct. 12, 2017

(54) TAPERED MICROSTRIP LEAKY WAVE ANTENNA

(71) Applicant: COMSATS Institute of Information Technology, Attock, Attock (PK)

(72) Inventors: Ismail Khan Tarklani, Attock (PK); Qaisar Fraz, Attock (PK); Shujat Ali Khan Tanoli, Attock (PK)

(21) Appl. No.: 15/479,236

(22) Filed: Apr. 4, 2017

(30) Foreign Application Priority Data
Apr. 6, 2016 (PK) 1972016

(51) Int. Cl. H01Q 13/20; H01Q 13/28; H01Q 19/30; H01Q 1/48

(52) U.S. Cl. CPC H01Q 13/203; H01Q 13/206; H01Q 1/48; H01Q 13/28; H01Q 19/30

(57) ABSTRACT

A tapered Microstrip Leaky Wave Antenna (MLWA) may include: a grounded metallic plane; conducting traces disposed on the grounded metallic plane, the conducting traces may include: a tapered leaky section extending in a first direction from a first end of the tapered leaky section to a second end of the tapered leaky section, the tapered leaky section including two rectangular slots; and a monopole disposed at the second end of the tapered leaky section and extending in a second direction, the second direction crossing the first direction, a dielectric layer disposed between the grounded metallic plane and the conducting traces; and three Yagi elements disposed adjacent to at the second end of the tapered leaky section in parallel with the monopole.

### CROSS-REFERENCE TO RELATED APPLICATION

This application claims priority from and the benefit of Pakistan Provisional Application No. 197/2016, filed on Apr. 06, 2016, which is hereby incorporated by reference for all purposes as if fully set forth herein.

### BACKGROUND

### Field

Exemplary embodiments relate to a Microstrip Leaky Wave Antenna.

### Discussion of the Background

W. W. Hansen invented the first known leaky wave antenna in 1940. It consisted of a rectangular waveguide with slits in the wall. Since then, many different leaky wave antenna types are reported. The majority of early leaky wave antennas consisted of closed waveguides. These waveguides had slits in the wall to allow the power to radiate. Different types of uniform, quasi uniform and periodic leaky wave antennas with one dimensional and two dimensional radiation characteristics have been designed.

A Microstrip Leaky Wave Antenna (MLWA) was first introduced in 1979, based on exciting first higher order mode (TE₀₁ mode). The MLWA proposed by Menzel has a length of 2.23λ and could radiate only 65% of the power. The remaining power reflects from the open end and produces a large back lobe. The length must be increased to 4.85λ to radiate 90% of the power. To radiate the power more efficiently and suppress the back lobes, the length must be increased to 5λ. The array topology suppresses back lobes up to 10.5 dB with a length of 2λ. The back lobes are further suppressed to 15 dB but with a length of 3λ by tapered loaded leaky wave antenna (LWA). By adding parasitic elements to the LWA, the back lobe can be suppressed to 12 dB at 6.9 GHz while the length is 2λ. All of the mentioned designs require large length of at least 2λ and a complicated structure.

Beam steering is often required in many scenarios. It can be done using different antenna types like phased arrays, and electronically steered parasitic array radiator (ESPAR), etc. These structures require phase shifters or complex structures for beam steering and shaping. Currently available phase shifters are based on micro-electromechanical systems (MEMS), semiconductor devices and ferroelectric techniques. Most of these need complex biasing and majority are temperature sensitive, and have poor power handling capability and high insertion loss.

In contrast, the Microstrip Leaky Wave Antenna (MLWA) does not need any complex feed network and is not affected by temperature variations. Since no additional feed components are needed, no insertion loss is presented by the MLWA. With all these, the MLWA is capable of frequency beam scanning. High beam steering is claimed in Fabry-Perot leaky wave antenna. A leaky wave antenna with beam steering capability based on metamaterial transmission line concept has been designed.

### SUMMARY

Exemplary embodiments provide a Microstrip Leaky Wave Antenna including a tapered leaky section including slots.

Additional aspects will be set forth in the detailed description which follows, and, in part, will be apparent from the disclosure, or may be learned by practice of the inventive concept.

An exemplary embodiment discloses a tapered Microstrip Leaky Wave Antenna (MLWA) that may include: a grounded metallic plane; conducting traces disposed on the grounded metallic plane, the conducting traces may include: a tapered leaky section extending in a first direction from a first end of the tapered leaky section to a second end of the tapered leaky section, the tapered leaky section including two rectangular slots; and a monopole disposed at the second end of the tapered leaky section and extending in a second direction, the second direction crossing the first direction, a dielectric layer disposed between the grounded metallic plane and the conducting traces; and three Yagi elements disposed adjacent to at the second end of the tapered leaky section in parallel with the monopole.

The grounded metallic plane may include two symmetric rectangular shape cut-outs overlapping at least a portion of the monopole and the Yagi elements.

The tapered leaky section may have length of 62 mm.

A width of the tapered leaky section may decrease from the first end having to the second end in a sequence of a first width a second width, a third width, and a fourth width, the first width being the width of the first end and the fourth width being the width of the second end.

The first width may be 15 mm, the second width may be 14 mm, the third width may be 13 mm, and the fourth width may be 12 mm.

The tapered leaky section may be terminated by the monopole.

The tapered leaky section may have two empty rectangular slots with a width of 10 mm and a length of 5 mm near the first end and the second end of the tapered leaky section, respectively.

Each of the three Yagi elements may have a length of 49 mm, and a width of 1 mm.

The three Yagi elements may be spaced apart at 1 mm from each other.

The Yagi elements may be configured to provide a reduction in side lobe level.

The two symmetric rectangular shape cut-outs may be configured to provide a further reduction in side lobe level.

The tapered leaky section may be configured to provide an increase in a frequency based beam scanning capability.

The two empty rectangular slots may be configured to improve frequency based scanning capability improved.

The Yagi elements may be configured to provide a symmetric radiation pattern.

The tapered leaky section, and the rectangular slots may be configured to provide an increase in gain of antenna.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a plan view of a high frequency structural simulator (HFSS) model of a Microstrip Leaky-wave antenna (MLWA) with asymmetric Yagi elements, according to a comparative embodiment.

FIG. 2 is a plan view of an HFSS model of an MLWA with symmetric Yagi elements, according to a exemplary embodiment.

FIG. 3 illustrates a Side Lobe Level (SLL) of the MLWA with the symmetric Yagi elements in comparison with the MLWA with asymmetric Yagi elements, according to the exemplary embodiments.

FIG. 4 illustrates a normalized H-Plane Pattern of the MLWA with the symmetric Yagi elements, according to the exemplary embodiment.

FIG. 5 illustrates a normalized E-Plane pattern of the MLWA with the symmetric Yagi elements at 4.7 GHz, according to the exemplary embodiment.

FIG. 6 illustrates a peak gain of the MLWA with the symmetric Yagi elements, according to the exemplary embodiment.

FIG. 7A is a plane view of an HFSS Model of a tapered MLWA including a tapered leaky section, according to an exemplary embodiment.

FIG. 7B is a detailed diagram of conducting traces of the tapered MLWA including the tapered leaky section, according to an exemplary embodiment.

FIG. 8 is an exemplary embodiment of the tapered MLWA with slots and symmetric Yagi elements fabricated according to the HFSS Model of a tapered MLWA of FIGS. 7A and 7B, according to an exemplary embodiment.

FIG. 9 illustrates a measurement of an SLL of the tapered MLWA with slots and symmetric Yagi elements of FIG. 8 and a simulation result of an SLL of the HFSS model of a tapered MLWA 700 of FIG. 7A, according to the exemplary embodiment.

FIG. 10 illustrates a simulated H-Plane of the tapered MLWA with slots and symmetric Yagi elements of FIG. 7A, according to the exemplary embodiment.

FIG. 11 illustrates a simulated E-Plane at 4.7 GHz of the tapered MLWA with slots and symmetric Yagi elements of FIG. 7A, according to the exemplary embodiment.

FIG. 12 illustrates a peak gain of the tapered MLWA with slots and symmetric Yagi elements of FIG. 8, according to the exemplary embodiment.

FIG. 13 graph illustrates a Beam Scanning of the tapered MLWA with slots and symmetric Yagi elements of FIG. 8 in comparison with the HFSS model of MLWAs with asymmetric and symmetric Yagi elements of FIGS. 2 and 3, according to the exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to plan and/or sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. As such, the regions illustrated in the drawings are schematic in nature and their shapes are not intended to illustrate the actual shape of a region of a device and are not intended to be limiting

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

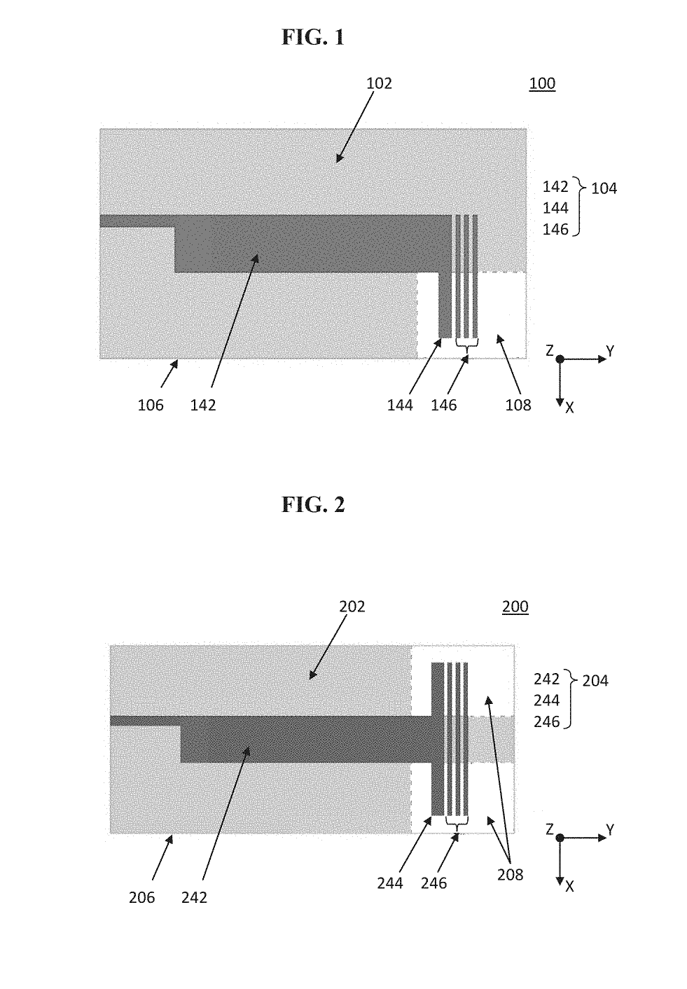

FIG. 1 is a plan view of a high frequency structural simulator (HFSS) model of a Microstrip Leaky-wave antenna (MLWA) 100 with asymmetric Yagi elements 146, according to a comparable embodiment. FIG. 2 is a plan view of an HFSS model of an MLWA 200 with symmetric Yagi elements 246, according to a exemplary embodiment.

According to FIG. 1, a design of the MLWA 100 with asymmetric Yagi elements 146 according to the comparative embodiment includes a typical microstrip leaky section which is amended with a monopole and Yagi elements 146 (or directors). This whole structure can be seen as a microstrip leaky wave antenna with asymmetric Yagi elements 146. When a conventional leaky wave antenna without monopole and Yagi elements is excited, the power leaks out of the leaky section but not hundred percent. The remaining power reflects back and causes increase in the side lobes. By using a monopole, the reflected power can be minimized through radiation from monopole but as the radiation from monopole is symmetric along the axis of the monopole, back lobe may increase.

Referring to FIG. 1, the MLWA 100 may include a grounded metallic plane 102, conducting traces 104 including a leaky section 142, a monopole 144, and asymmetric Yagi elements 146. The monopole 144 and the asymmetric Yagi elements 146 are disposed extending in a first direction (or an X-direction), and the leaky section 142 extends in a second direction (or a Y-direction). a dielectric layer 106 may be disposed between the grounded metallic plane 102 and the conducting traces 104. The grounded metallic plane 102 may include a cut-out 108. The cut-out 108 may have a rectangular shape. The cut-out may overlap at least a portion of the monopole 144 and the asymmetric Yagi elements 146.

Referring to FIG. 2, the MLWA 200 may include a grounded metallic plane 202, conducting traces 204 including a leaky section 242, a monopole 244, and symmetric Yagi elements 246. The monopole 244 and the symmetric Yagi elements 246 are disposed extending in the first direction, and the leaky section 242 extends in the second direction. A dielectric layer 206 may be disposed between the grounded metallic plane 202 and the conducting traces 204. The grounded metallic plane 202 may include two cut-outs 208. The cut-outs 208 may have symmetrical shapes. For example, the cut-outs 208 may have rectangular shapes. The cut-outs 208 may be symmetrically disposed in the first direction, overlapping at least a portion of the monopole 244 and the symmetric Yagi elements 246 including two distal ends of the monopole 244 and the symmetric Yagi elements 246. The leaky wave antenna with symmetric Yagi elements 246 according to an exemplary embodiment may reduce the side lobes and the back lobe.

The grounded metallic plane 202 and the conducting traces 204 may include various kinds of metal. The grounded metallic plane 202 and the conducting traces 204 may include, for example, but not limited to, copper. The grounded metallic plane 202 and the conducting traces 204 made of copper may have a conductivity of 5.8×10⁷ S/m. The dielectric layer 206 may include various kinds of dielectric material. For example, the dielectric layer 206 may be a FR-4 substrate with dielectric constant 4.4 and loss tangent 0.02.

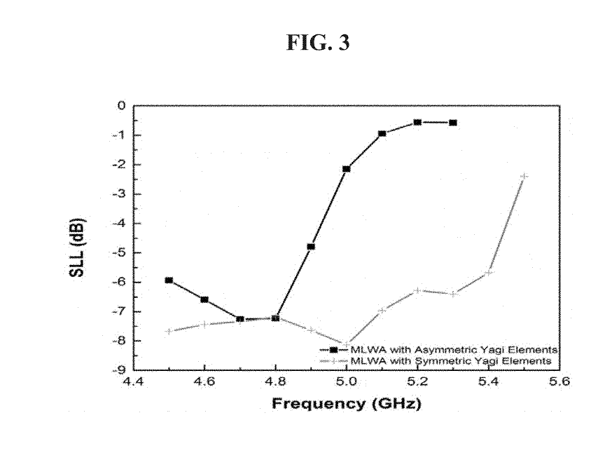

With reference to FIGS. 3, 4, 5, and 6, a simulation result of the MLWA 200 with the symmetric Yagi elements 246 is discussed in detail in comparison with a simulation result of the MLWA 100 with the asymmetric Yagi elements 146.

FIG. 3 illustrates an SLL of the MLWA 200 with the symmetric Yagi elements 246 in comparison with the MLWA 100 with asymmetric Yagi elements 146, according to the exemplary embodiments. Referring to FIG. 3, the MLWA 200 with symmetric Yagi elements 246 according to the exemplary embodiment may have reduced back lobe and the SLLs in comparison with the MLWA 100 with asymmetric Yagi elements 146.

The graph shows that the SLL of MLWA 200 with symmetric Yagi elements 246 is better than that of MLWA 100 with asymmetric Yagi elements 146. The MLWA 100 with asymmetric Yagi elements 146 has the SLL less than 2 dB beyond 5 GHz, and the MLWA 200 with symmetric Yagi elements 246 has more than 5 dB throughout the working frequency band of 4.5 to 5.4 GHz.

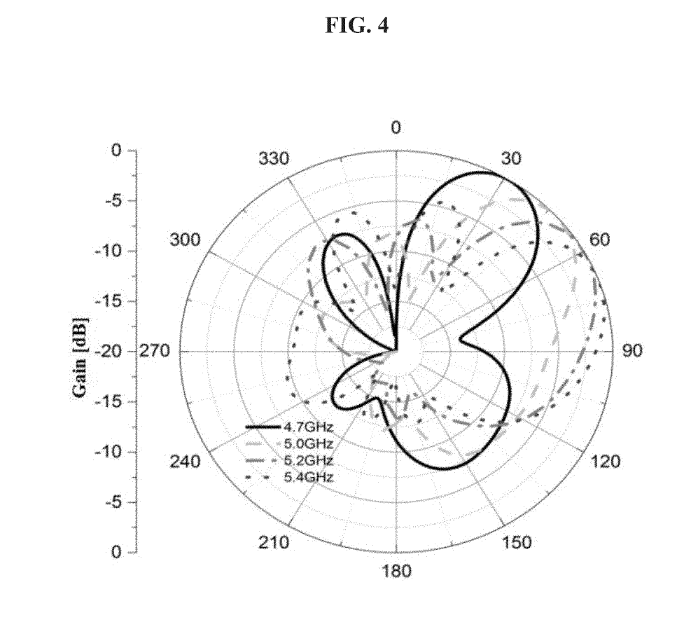

FIG. 4 illustrates a normalized H-Plane Pattern of the MLWA 200 with the symmetric Yagi elements 246, according to the exemplary embodiment. FIG. 4 shows the frequency scanning capability of MLWA 200 with symmetric Yagi elements 246. The MLWA 200 with the symmetric Yagi elements 246 according to the exemplary embodiment has beam scanning capability between 22° to 70° over a frequency range of 4.5 GHz to 5.4 GHz.

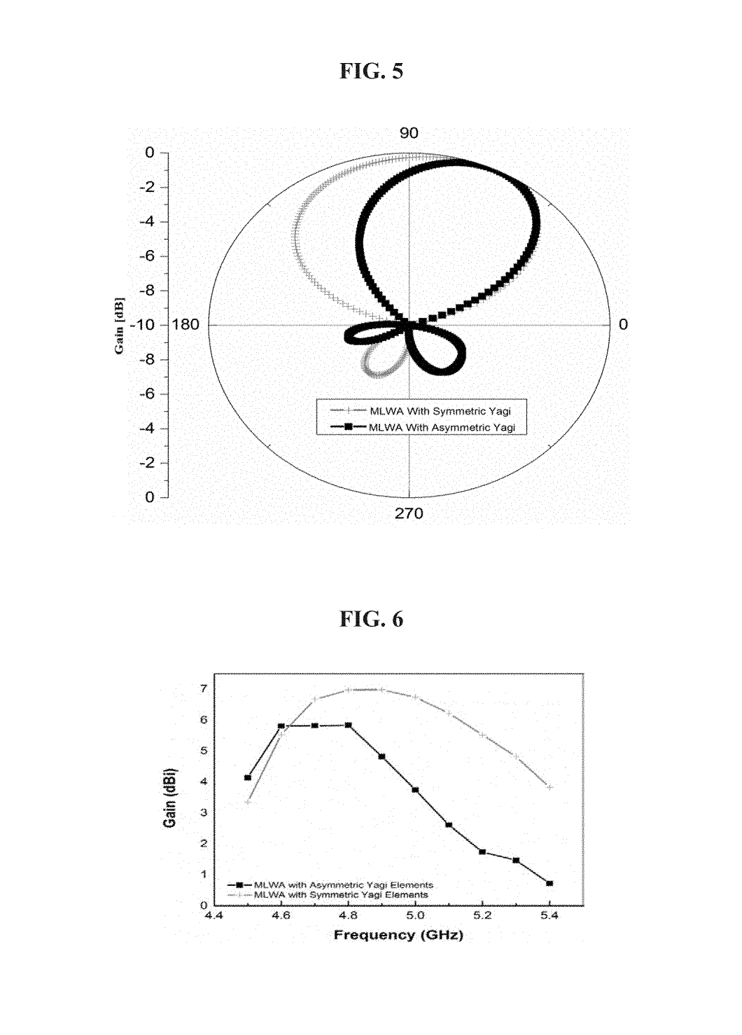

FIG. 5 illustrates a normalized E-Plane pattern of the MLWA 100 with the asymmetric Yagi elements 146 and the MLWA 200 with the symmetric Yagi elements 246 at 4.7 GHz, according to the exemplary embodiment. The E-plane of the MLWAs 100 and 200 according to the exemplary embodiments has the peak along the longitudinal axis. The side lobes in this plane grow larger with the frequency above 5 GHz. Referring to FIG. 5, the E-plane at 4.7 GHz of both the MLWA 100 with the asymmetric Yagi elements 146 and the MLWA 200 with the symmetric Yagi elements 246 at 4.7 GHz is illustrated for comparison. It is clear that the shift in the elevation radiation plane is reduced when symmetric Yagi elements 246 and a corresponding cut-outs 208 included in the ground plane are introduced. This restores the antenna radiation pattern. End-fire radiation may also be observed.

FIG. 6 illustrates a peak gain of the MLWA 200 with the symmetric Yagi elements 246, according to the exemplary embodiment. The graph shows that peak gain of MLWA with Yagi elements shows the same behavior in symmetric as well as asymmetric case. But the peak gain of the MLWA 200 with the symmetric Yagi elements 246 remains above 4 dB at frequencies above 5 GHz, which is improvement in comparison with the MLWA 100 with the asymmetric Yagi elements 146. the gain of the MLWA 100 with the asymmetric Yagi elements 146 rapidly decreases above 5 GHz.

The overall performance of the MLWA 200 with symmetric Yagi elements 246 according to the exemplary embodiments is summarized in Table 1

TABLE 1
Overall Performance of MLWA 200
with Symmetric Yagi Elements 246

| Parameter | Value |
|---|---|
| Impedance Bandwidth | 4.6~5.2 GHz |
| Beam Scanning | 22°~70° |
| SLL | >5.5 dB throughout the Band |
| Peak Gain | >3.8 dB throughout the Band |

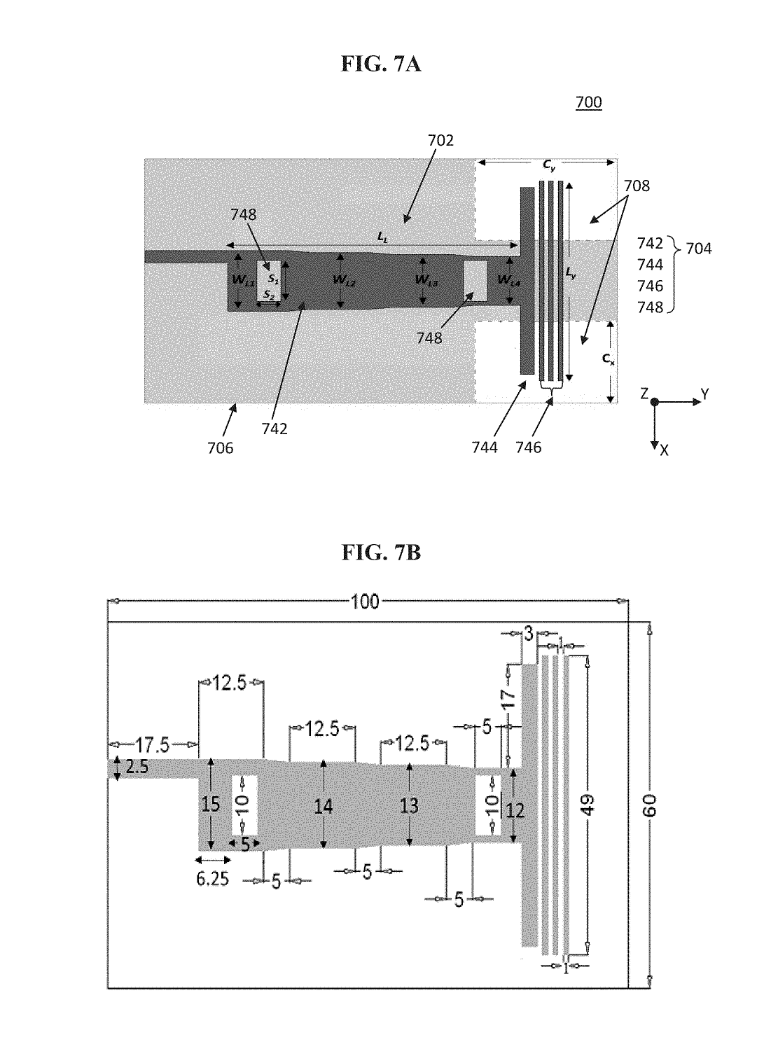

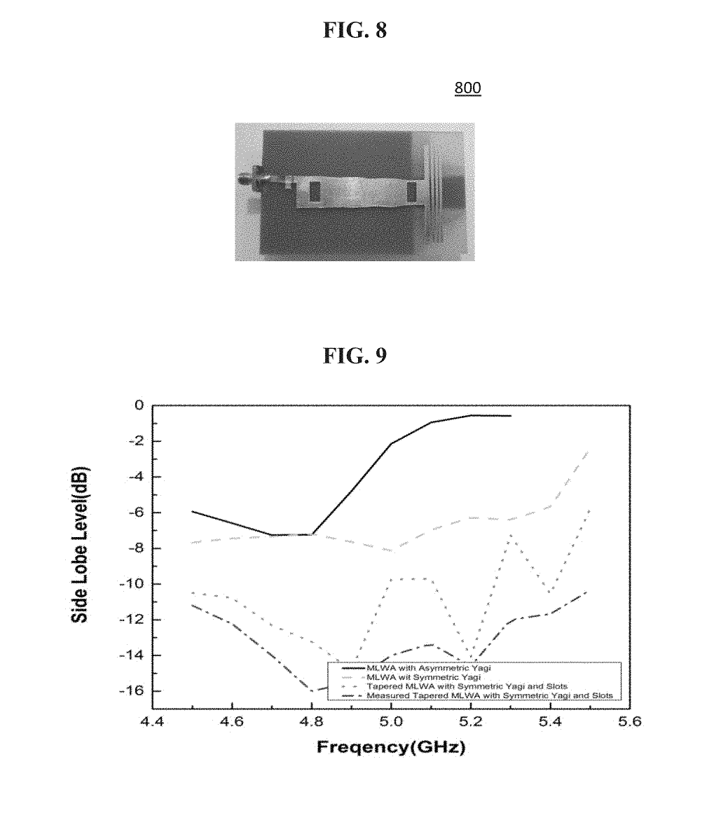

According to the exemplary embodiments, a tapered MLWA with Slots and Symmetric Yagi Elements may be provided. FIG. 7A is a plane view of an HFSS model of a tapered MLWA 700 including a tapered leaky section 742, according to an exemplary embodiment. FIG. 7B is a detailed diagram of conducting traces 704 of the tapered MLWA 700 including a tapered leaky section 742, according to an exemplary embodiment. FIG. 8 is an exemplary embodiment of the tapered MLWA with slots and symmetric Yagi elements fabricated according to the HFSS Model of a tapered MLWA of FIGS. 7A and 7B, according to an exemplary embodiment.

Referring to FIG. 7A, the tapered MLWA 700 according to the exemplary embodiment may include a grounded metallic plane 702, conducting traces 704 including the tapered leaky section 742, a monopole 744, and symmetric Yagi elements 746. The monopole 744 and the symmetric Yagi elements 746 are disposed extending in the first direction, and the tapered leaky section 742 extends in the second direction. The tapered leaky section 742 according to the exemplary embodiment is different from the previous two exemplary embodiments. Two slots 748 are formed in the tapered leaky section 742 having same dimensions. A length of the Yagi elements 746 (or directors) are longer than that of the monopole 744. A dielectric layer 706 may be disposed between the grounded metallic plane 702 and the conducting traces 704. The overall dimensions of the tapered MLWA 700 are 60 mm in width and 100 mm in length which are smallest of the two designs discussed earlier.

The grounded metallic plane 702 and the conducting traces 704 may include various kinds of metal. The grounded metallic plane 702 and the conducting traces 704 may include, for example, but not limited to, copper. The grounded metallic plane 702 and the conducting traces 704 made of copper may have a conductivity of 5.8×10⁷ S/m. The dielectric layer 706 may include various kinds of dielectric material. For example, the dielectric layer 706 may be a FR-4 substrate with dielectric constant 4.4 and loss tangent 0.02.

The grounded metallic plane 702 may include two cut-outs 708. The cut-outs 708 may have symmetrical shapes. For example, the cut-outs 708 may have rectangular shapes. The cut-outs 708 may be symmetrically disposed in the first direction, overlapping at least a portion of the monopole 744 and the symmetric Yagi elements 746 including two distal ends of the monopole 744 and the symmetric Yagi elements 746. The cut-outs 708 may reduce the SLL and make the antenna pattern symmetric.

Referring to FIG. 7B, the tapered MLWA 700 may have following physical dimensions in millimeters: L_{L}=62, Cₓ=20, C_{y}=30, L_{y}=49, W_{L1}=15, W_{L2}=14, W_{L3}=13, W_{L4}=12, S₁=10, and S₂=5. FIG. 8 is the tapered MLWA 800 with slots and symmetric Yagi elements fabricated according to the HFSS Model of a tapered MLWA 700 of FIGS. 7A and 7B. With reference to FIGS. 9, 10, 11, 12, and 13, a simulation result of the HFSS model of a tapered MLWA 700 including a tapered leaky section 742 as illustrated in FIG. 7A and the measurement result of the tapered MLWA 800 with slots and symmetric Yagi elements fabricated according to the HFSS Model of a tapered MLWA 700 as illustrated in FIG. 8 are discussed in detail in comparison with the simulation results of the simulation result of the MLWA 100 with the asymmetric Yagi elements 146 as illustrated in FIG. 1 and the MLWA 200 with the symmetric Yagi elements 246 as illustrated in FIG. 2.

FIG. 9 illustrates a measurement of an SLL of the tapered MLWA 800 with slots and symmetric Yagi elements of FIG. 8 and a simulation result of an SLL of the HFSS model of a tapered MLWA 700 of FIG. 7A, according to the exemplary embodiment. Referring to FIG. 9, the SLL remains more than 10 dB up to 5.4 GHz and corresponds to an angular position of 61°, which is improved from the simulation results of the simulation result of the MLWA 100 with the asymmetric Yagi elements 146 as illustrated in FIG. 1 and the MLWA 200 with the symmetric Yagi elements 246 as illustrated in FIG. 2

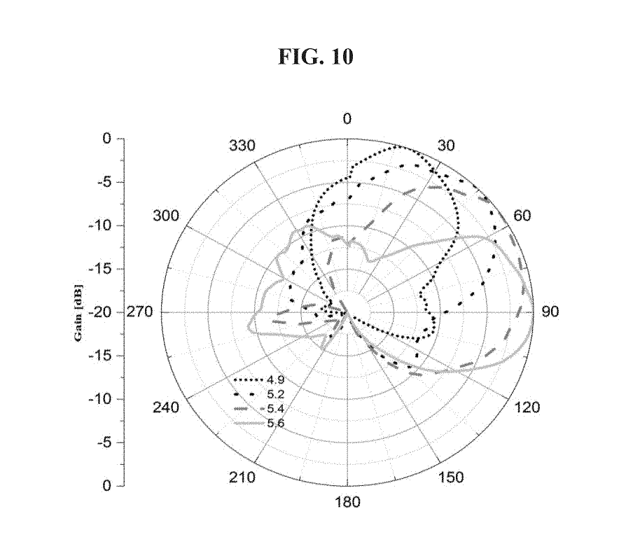

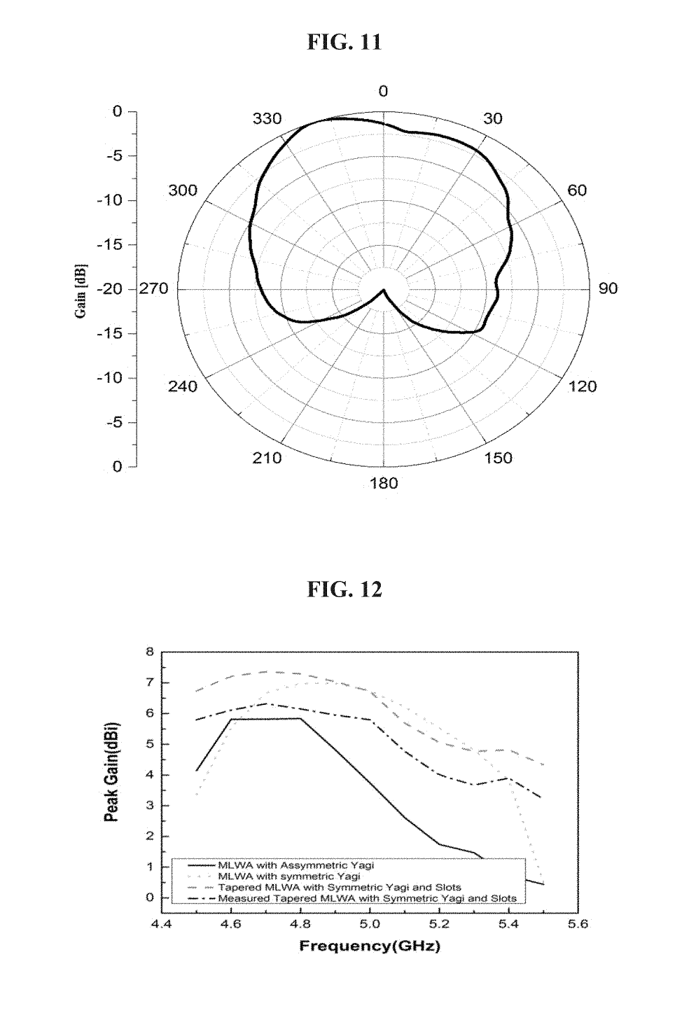

FIG. 10 illustrates a simulated H-Plane of the tapered MLWA with slots and symmetric Yagi elements of FIG. 7A, according to the exemplary embodiment. Referring to FIG. 10, the frequency scanning capability of the tapered MLWA with slots and symmetric Yagi elements is shown in FIG. 11. The polar plot shows that the tapered MLWA with slots and symmetric Yagi elements has beam scanning capability between 17° at 4.9 GHz to 90° at 5.6 GHz thus covering a wide angular range of 73°. This frequency scanning capability has not been observed in the simulation results of the simulation result of the MLWA 100 with the asymmetric Yagi elements 146 as illustrated in FIG. 1 and the MLWA 200 with the symmetric Yagi elements 246 as illustrated in FIG. 2. Accordingly, the tapered MLWA with slots and symmetric Yagi elements has improved beam scanning capability.

FIG. 11 illustrates a simulated E-Plane at 4.7 GHz of the tapered MLWA with slots and symmetric Yagi elements of FIG. 7A, according to the exemplary embodiment. Referring to FIG. 11, the elevation plane is symmetric about the longitudinal axis of the antenna.

FIG. 12 illustrates a peak gain of the tapered MLWA with slots and symmetric Yagi elements of FIG. 8, according to the exemplary embodiment.

Referring to FIG. 12, peak gain of the said antenna remains in acceptable range of 3.8 dB to 6.1 dB throughout the working band of 4.5 GHz to 5.4 GHz.

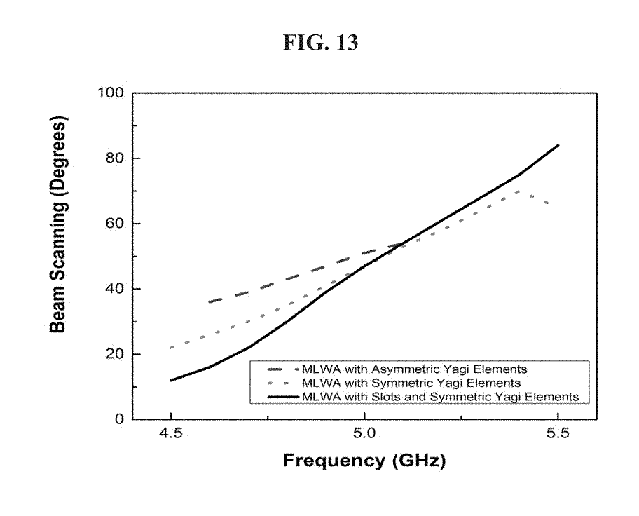

FIG. 13 graph illustrates a Beam Scanning of the tapered MLWA with slots and symmetric Yagi elements of FIG. 8 in comparison with the HFSS model of MLWAs with asymmetric and symmetric Yagi elements of FIGS. 2 and 3, according to the exemplary embodiments.

The tapered MLWA 700 and 800 including: 1) tapering leaky section; 2) two slots of equal dimensions in the tapered leaky section; 3) symmetric Yagi elements along leaky section; and 4) two symmetric cuts in the ground plane according to FIGS. 7A, 7B, and 8 may have improved characteristics. The overall performance of the tapered MLWA 700 and 800 according to the exemplary embodiments in comparison with performance of comparative embodiments is provided in Table 2 and FIG. 13. The tapered MLWA with slots and symmetric Yagi elements has an almost linear and broader beam scanning (12° to 84°) behavior with respect to increase in frequency from 4.5 to 5.5 GHz. the tapered MLWA with slots and symmetric Yagi elements also show the antenna gain remains in acceptable range of 3.8 dB to 6.1 dB throughout the working band.

TABLE 2
Performance of tapered MLWA in comparison
with the comparable embodiments.

| | Working | Beam | Avg. Side |
|---|---|---|---|
| | Frequency Band | Scanning | Lobe Level |
| Antenna Type | (GHz) | (Degrees) | (dB) |
| MLWA with Asymmetric | 4.6~5.1 | 36~54 | 2 |
| Yagi Elements | | | |
| MLWA with Slots and | 4.5~6.5 | 8~57 | 5 |
| Shorting Pin | | | |
| MLWA with Symmetric | 4.5~5.4 | 22~70 | 5 |
| Yagi Elements | | | |
| MLWA with Symmetric | 4.5~4.9 | 82~94 | 7 |
| Yagi and Superstrate | | | |
| Tapered MLWA with Slots | 4.5~5.5 | 12~84 | 6 |
| and Symmetric Yagi | | | |
| (proposed design) | | | |

The exemplary embodiments relate to a tapered Microstrip Leaky Wave Antenna (MLWA) with reduced SLL, increased frequency scanning range and increased gain. The tapered MLWA according to the exemplary embodiments may have all these attributes by keeping its size relatively smaller (1.8λ). Symmetric Yagi elements are introduced which are used to reduce the SLL and make the radiation plane (H Plane) symmetric. The tapered MLWA has structure made tapered to further reduce the SLL and increase frequency scanning capability. The tapered MLWA has more gain than comparable embodiments. The frequency beam scanning is also improved by having a value of 84°.

Accordingly, the tapered MLWA according to the exemplary embodiments may have the following enhancements: reduced SLL; increased frequency scanning capability; compact and smaller size; and symmetric radiation pattern.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A tapered Microstrip Leaky Wave Antenna (MLWA) comprising:
a grounded metallic plane;
conducting traces disposed on the grounded metallic plane, the conducting traces comprising:
a tapered leaky section extending in a first direction from a first end of the tapered leaky section to a second end of the tapered leaky section, the tapered leaky section comprising two rectangular slots; and
a monopole disposed at the second end of the tapered leaky section and extending in a second direction, the second direction crossing the first direction,
a dielectric layer disposed between the grounded metallic plane and the conducting traces; and
three Yagi elements disposed adjacent to at the second end of the tapered leaky section in parallel with the monopole.

2. The MLWA of claim 1, wherein the grounded metallic plane comprises two symmetric rectangular shape cut-outs overlapping at least a portion of the monopole and the Yagi elements.

3. The MLWA of claim 1, wherein the tapered leaky section has length of 62 mm.

4. The MLWA of claim 1, wherein a width of the tapered leaky section decreases from the first end having to the second end in a sequence of a first width a second width, a third width, and a fourth width, the first width being the width of the first end and the fourth width being the width of the second end.

5. The MLWA of claim 4, wherein the first width is 15 mm, the second width is 14 mm, the third width is 13 mm, and the fourth width is 12 mm.

6. The MLWA of claim 1, wherein the tapered leaky section is terminated by the monopole.

7. The MLWA of claim 6, wherein the tapered leaky section has two empty rectangular slots with a width of 10 mm and a length of 5 mm near the first end and the second end of the tapered leaky section, respectively.

8. The MLWA of claim 1, wherein each of the three Yagi elements has a length of 49 mm, and a width of 1 mm.

9. The MLWA of claim 1, wherein the three Yagi elements are spaced apart at 1 mm from each other.

10. The MLWA of claim 1, wherein the Yagi elements are configured to provide a reduction in side lobe level.

11. The MLWA of claim 2, wherein the two symmetric rectangular shape cut-outs are configured to provide a further reduction in side lobe level.

12. The MLWA of claim 1, wherein the tapered leaky section is configured to provide an increase in a frequency based beam scanning capability.

13. The MLWA of claim 7, wherein the two empty rectangular slots are configured to improve a frequency based scanning capability.

14. The MLWA of claim 1, wherein the Yagi elements are configured to provide a symmetric radiation pattern.

15. The MLWA of claim 1, wherein Yagi elements, the tapered leaky section, and the rectangular slots are configured to provide an increase in gain of the antenna.
